(19) United States
(12) Patent Application Publication
(10) Pub. No.: US 2019/0288972 A1
(43) Pub. Date: Sep. 19, 2019

(54) REVEAL POSTS IN A CONTENT SHARING PLATFORM

(71) Applicant: Phanto, LLC, Scottsdale, AZ (US)

(72) Inventor: Daniel Morrison, Scottsdale, AZ (US)

(21) Appl. No.: 16/357,156

(22) Filed: Mar. 18, 2019

Related U.S. Application Data
(60) Provisional application No. 62/644,576, filed on Mar. 18, 2018.

(51) Int. Cl. H04L 12/58; G06T 11/60

(52) U.S. Cl. CPC H04L 51/16; G06T 11/60; H04L 51/10; H04L 51/32

(57) ABSTRACT

Systems and methods are provided for displaying variable view content items on an online platform for disseminating user-contributed content items, i.e. in a social media environment. The variable view content items include an image and one or more obfuscations (such as graphic overlays) applied to the image by an originating user. The variable view content item may be published to one or more viewing users, such as via inclusion of the variable view content item within a social media feed. The viewing user may interact with the variable view content item to reveal the image without obfuscations.

### TECHNICAL FIELD

Embodiments of the present disclosure relate in general to content posts on social media services, and in particular to computer-implemented systems and methods to interactively utilize image-based content on network-based platforms for sharing or communication of user-contributed content.

### BACKGROUND

In recent years, social media services and other online communication services have become increasingly important avenues for human communication. For many individuals, online platforms have become a primary method by which they communicate. Such services include, without limitation, Facebook®, Youtube®, Google+®, Instagram®, Snapchat®, online forums and chatrooms. Meanwhile, messaging apps (such as WhatsApp®) have also become popular social media platforms for more targeted distribution of user-contributed content.

Social platforms increasingly utilize photographs and other images as forms of user-contributed content for purposes of communicating with and interacting with others. For example, as both a form of entertainment and personal expression, many users of social apps enjoy making images into clever statements by overlaying short text statements, such as memes, or longer text statements in a diary format (often combined with stickers), such as niche memes. These and other types of image-based content can provide an increasingly valuable form of self-expression on social media applications. Therefore, it may be desirable for such platforms to develop capabilities further encouraging various forms of image-based communications.

### SUMMARY

In accordance with one aspect of the disclosure, a method is provided for displaying a user-contributed content item on an electronic device having a display, interacting with one or more servers over a digital communications network implementing a platform enabling distribution of user-contributed content items, such as a social media platform or messaging platform. An originating user generates a user-contributed content item that includes an image, which may be uploaded by the originating user, using the user computing device interacting with the servers. The originating user configures an initial view of the user-contributed content item by positioning one or more obfuscations on the image. Obfuscations may include, for example, graphic overlays or digital stickers, digital filters, distortions, or other visual effects. Each obfuscation obscures or conceals a portion of the image. The obfuscations may be selected by the originating user from amongst a plurality of obfuscation options. An initial view of the user-contributed content item is then published to one or more viewing users. A viewing user may interact with the post, such as by tapping or clicking the image, to display the image without obfuscations.

In some embodiments, the user-contributed content item may be initially displayed as a post in a user-contributed content feed. Upon interaction with the post, in some embodiments, the view without obfuscations may be displayed directly within the feed. In other embodiments, the view without obfuscations may be displayed in a content post-specific view. In yet other embodiments, selection of a content item in a social media feed may initially generate a content post-specific view, with further interaction required to reveal the image without obfuscations. Content post-specific views may include a text caption, feedback display region which may display feedback content from other users, and/or a feedback message entry field. A view toggle indicium may also be provided, selection of which may toggle a content post view between a few including the obfuscations, and a view excluding the obfuscations.

In accordance with another aspect of the disclosure, a method is provided for displaying a content feed in a social network environment. A social media content feed including multiple content items is displayed on a personal electronic device display screen. The social media feed content items include a variable view content item contributed by an originating user. The variable view content item includes an image and one or more obfuscations positioning on the image by the originating user having created the variable view content item. User interaction with the variable view content item is detected. The method then includes displaying an alternative view of the variable view content item that includes the image but excludes the obfuscations.

Various other objects, features, aspects, and advantages of the present invention and embodiments will become more apparent from the following detailed description of preferred embodiments, along with the accompanying drawings in which like numerals represent like components.

### BRIEF DESCRIPTION OF THE FIGURES

FIG. 1 is a schematic block diagram of a computing environment.

FIG. 2 is a schematic block diagram of a user computing device.

FIG. 3A is a flow chart of a process for generating reveal posts.

FIG. 3B is a flow chart of a process for displaying reveal posts.

FIG. 3C is a flow chart of another process for displaying reveal posts.

FIG. 3D is a flow chart of yet another process for displaying reveal posts.

FIGS. 4-8 are user interface displays for generating reveal posts.

FIG. 9 is a reveal post displayed within a social media feed, with graphic overlay.

FIG. 10 is a reveal post view with original image content revealed.

FIG. 11 is a reveal post view with graphic overlay applied.

FIG. 12 is a reveal post displayed within a social media feed, with original image content revealed.

### DETAILED DESCRIPTION OF THE DRAWINGS

While this invention is susceptible to embodiment in many different forms, there are shown in the drawings and will be described in detail herein several specific embodiments, with the understanding that the present disclosure is to be considered as an exemplification of the principles of the invention to enable any person skilled in the art to make and use the invention, and is not intended to limit the invention to the embodiments illustrated.

Providing another form of entertainment and personal expression, various systems and methods are described for implementing an image-based communication sometimes referred to herein as a reveal post, or alternatively, a variable view content item, which may be provided within a social network environment. Social network platforms typically enable dissemination of user-contributed content to other users. Types of content dissemination offered by various social network platforms may include one or more of: posting user-contributed content publicly (e.g. in a public social feed), posting content to a limited audience (e.g. to a content feed for which access is limited based on predetermined criteria, such as a friend feed), or to an explicitly-stated audience (such as a messaging application enabling group or one-to-one messaging). In some embodiments, a reveal post or variable view content item can be created by allowing a user to upload an image or video, and providing the user with editing tools to apply obfuscations to a portion of the image. An obfuscation, for purposes of this disclosure, is a visual effect that may be applied to obscure a portion of an image (whether still or video). Obfuscations that may be applied include graphic overlays (such as digital “stickers”), text, image filters, distortions or other graphical manipulations. Obfuscations may be applied to portions of the uploaded content, thereby creating a modified version of the image. The modified version often acts to conceal a portion of the image, or make it into a distorted version, or make it look like another thing entirely (such as AR software used for swapping people's heads or faces).

In a reveal post, both versions of the image or video are published. The default view, or first view presented to viewing users, is the modified version having obfuscations applied. Reveal posts containing images and/or videos may often be accompanied by a caption or other text message, but do not need to be. By taking an action on the default view, the viewing user can “reveal” the original version of the post, thereby seeing the post in its original form, lifting the intrigue, and providing the intentionally missing context. The result may provide an entertaining and engaging new format for exchanging messages or telling stories.

Reveal posts can be published on a public Internet website or through a software application on a mobile device or desktop computer, or any number of other ways. They can be made for viewing by the public at large through a publicly searchable web site, by a handpicked group of one or more individual “recipients” such as in a social network or private messaging service, or by a subset of a website or app's users such as followers of a hashtag or members of a closed online group.

Reveal posts may be implemented over a network through any number of architectures, such as through a centralized server connected to a network, peer to peer, or over a decentralized network such as a blockchain.

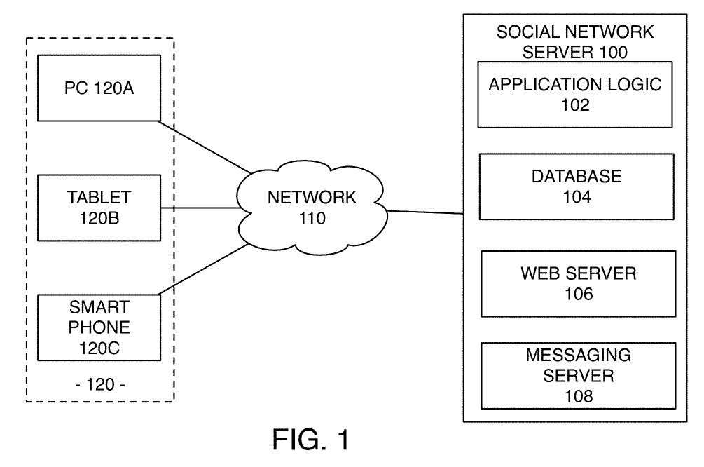

FIG. 1 is schematic block diagram of an embodiment of an online communication platform, such as a social media service. Server 100 communicates, inter alia, via computer network 110, which may include the Internet, with user devices 120 such as personal computer 120A, tablet computer 120B and smart phone 120C. While certain illustrated embodiments are implemented using smartphones, tablets or other mobile devices as user devices, it is contemplated and understood that embodiments may also be used with personal computers and any other digital electronic device that a user may use to access social media or other network-based digital communication services.

Server 100 implements application logic 102, and operates to store information within, and retrieve information from, database 104. The term “database” is used herein broadly to refer to an indexed store of data, whether structured or not, including without limitation relational databases and document databases. Web server 106 hosts one or more Internet web sites and/or Application Programming Interfaces (APIs) enabling outside user interaction with, amongst other things, application logic 102 and database 104. Messaging server 108 enables messaging, such as mobile network messaging service (e.g. SMS or MMS), email, and/or application notifications, between server 100 and user devices 120.

While depicted in the schematic block diagram of FIG. 1 as a block element with limited sub elements, as known in the art of modern web applications and network services, server 100 may be implemented in a variety of ways, including in a distributed computing environment where tasks are performed by remote processing devices that are linked through a communications network. In a distributed computing environment, program modules may be located in both local and remote computer storage media including memory storage devices. That said, the implementation of server 100 will typically include, at some level, one or more physical servers, at least one of the physical servers having one or more microprocessors and digital memory for, inter alia, storing instructions which, when executed by the processor, cause the server to perform methods and operations described herein.

Typically, server 100 interacts with user devices 120 to render a user interface, enabling communication of information to users of devices 120 and interaction between user devices 120 and server 100. Examples of user interfaces may include, inter alia, a mobile app graphical user interface rendered on a touch-sensitive display screen of a smartphone; or a web application rendered on web browser software running on a personal computer equipped with a keyboard and mouse. These and other embodiments facilitate implementation of methods and systems described herein.

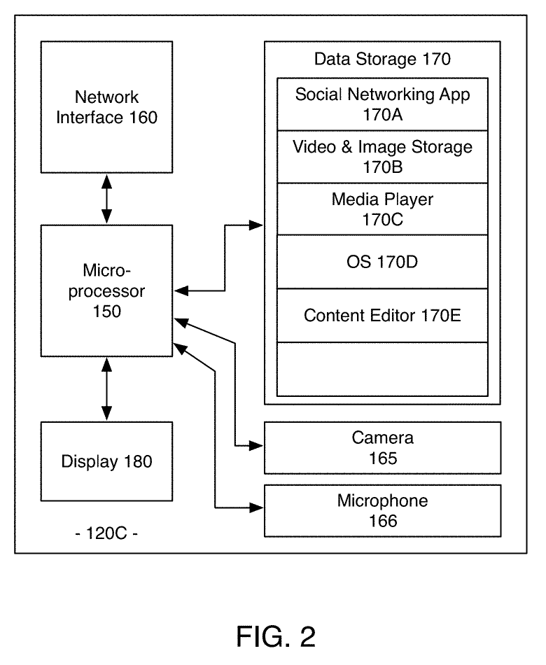

FIG. 2 is a schematic block diagram of an exemplary user device, smart phone 120C. Smart phone 120C includes microprocessor 150. Microprocessor 150 is configured to transfer data back and forth with data storage 170. Data storage 170 includes, inter alia, social networking application 170A, video and image storage 170B, media player 170C, operating system software 170D, and content editor 170E. Social networking application 170A enables interaction between user device 120C and a social networking service, and may be implemented via, e.g., a locally-installed application and/or a web application implemented using web browser software. Video and image storage 170B stores digital video and image content, such as user-generated photos and videos. Media player 170C contains instructions that can be executed by microprocessor 150 to render media content on display 180, such as video clips and images. Operating system software 170D contains instructions that can be executed by microprocessor 150 to implement a computing device operating system. Content editor 170E contains instructions that can be executed by microprocessor 150 to enable a user to interactively modify content including digital images and/or video stored within video and image storage 170B.

Device 120C further includes digital camera 165, capable of recording digital images and digital video content for storage within video and image storage 170B. Network interface 160 enables data communications with external networks, and may include common communication mechanisms including a cellular modem, Bluetooth interface and/or wireless Ethernet interface. Touchscreen display 180 enables user interaction with device 120C.

It should be appreciated by those of ordinary skill in the art that FIGS. 1 and 2 depict the various computing devices and environments in a simplified manner for purposes of clarity, and practical embodiments may include additional components and suitably configured processing logic to support known or conventional operations and functionality not described in detail herein.

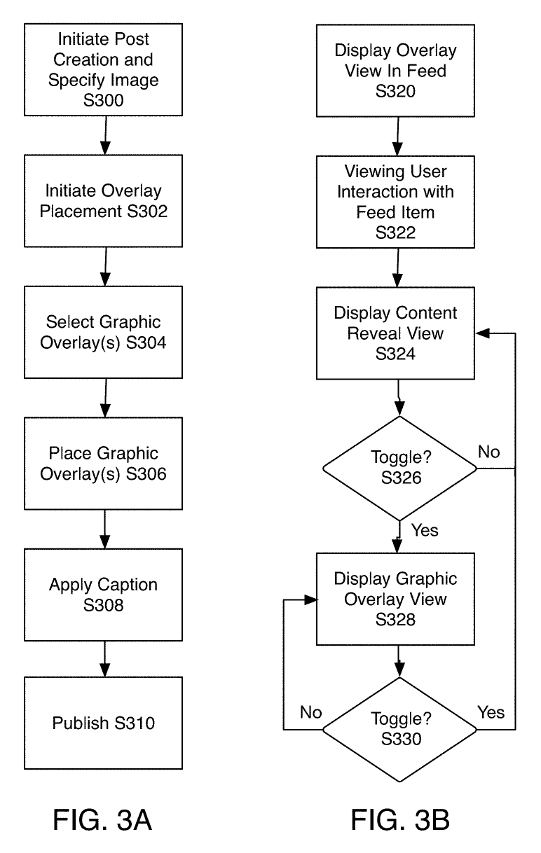

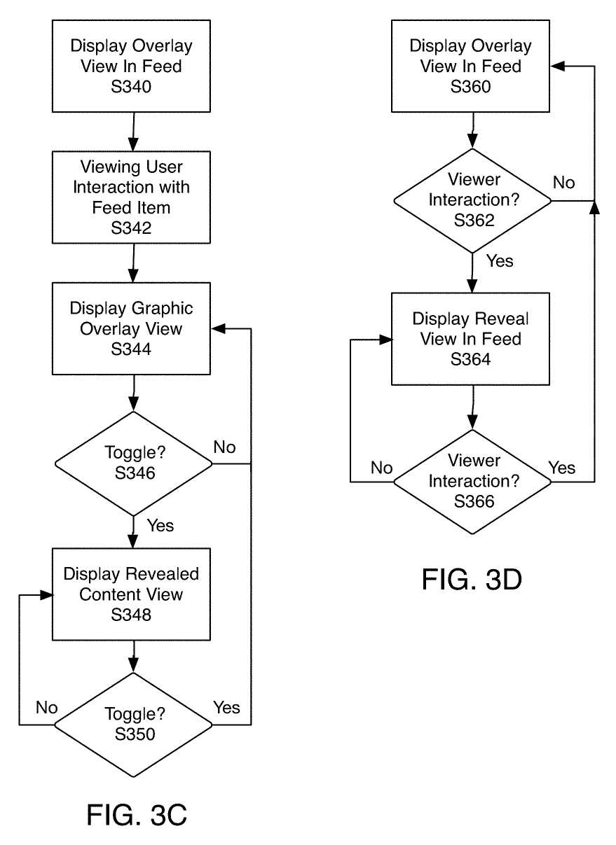

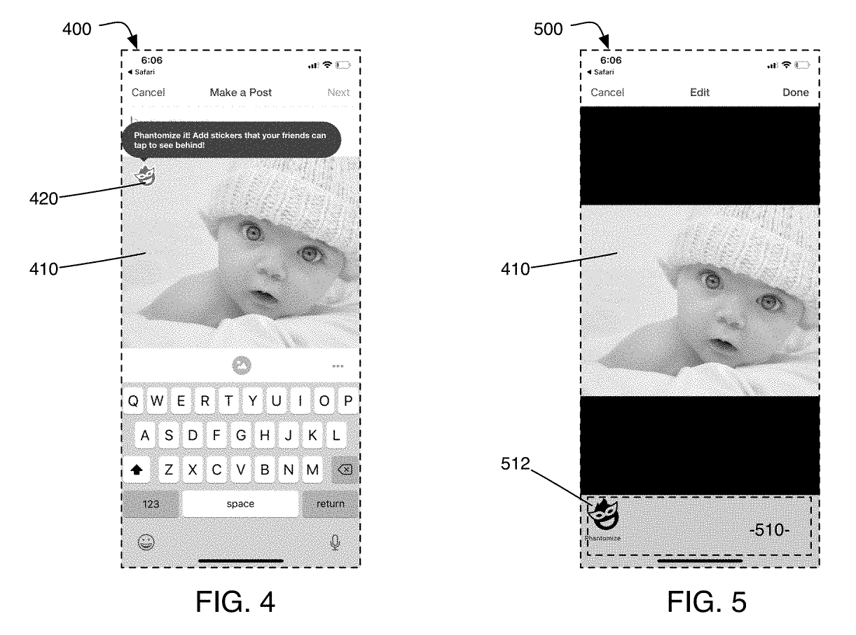

FIG. 3 is a flow chart of a process for generating a reveal post using a social media service. The process of FIG. 3 can be implemented by, for example, devices such as that of FIG. 2, and/or in a computing environment such as that of FIG. 1. FIGS. 4-8 illustrate application embodiments that may be rendered on a user device, such as smartphone 120C, while implementing the process of FIG. 3.

In step S300, an originating user utilizes a device 120 in order to initiate creation of a reveal post on social networking platform 100, e.g. by uploading an image from device 120, selecting an image stored locally on device 120, or otherwise specifying an image. FIG. 4 illustrates a mobile application display 400 rendered by smartphone 120C, interacting with social media service 100, to initiate a post, specifying image 410 as the underlying post content. In step S302, a user selects indicium 420 to initiate placement of obfuscations (in the embodiment of FIGS. 4-8, digital stickers or other temporarily concealing graphic overlay elements), to one or more portions of image 410, thereby rendering display 500 (FIG. 5) on user device 120. Display 500 includes image 410, as well as initial graphic overlay selection area 510, having indicia for one or more obfuscations (in this case, sticker packs i.e. collections of graphic overlays) such as pack 512.

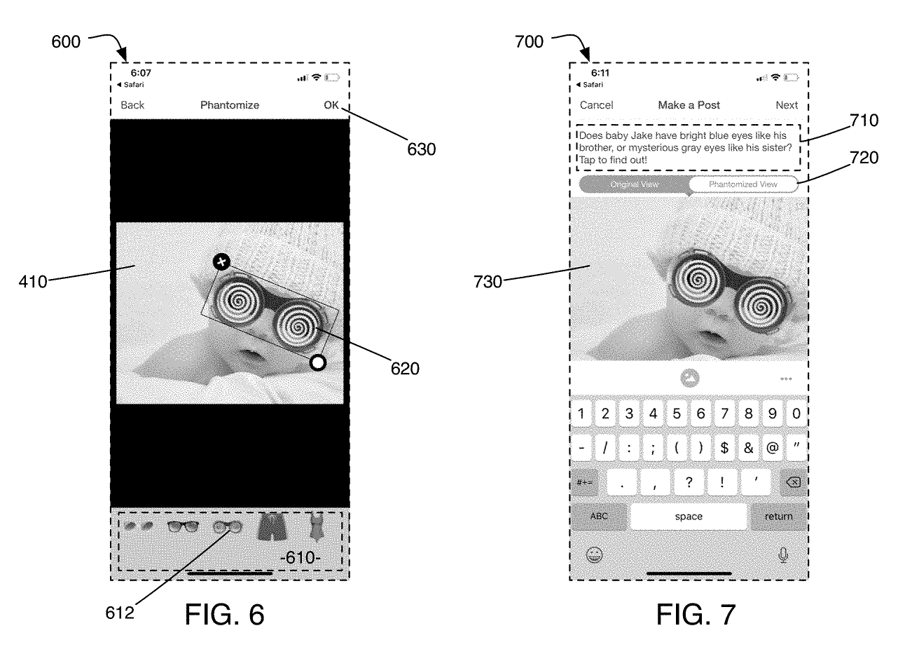

The user may then select an obfuscation for application to the original image content. For example, in step S304, the originating user selects a sticker pack 512, causing device 120 to render sticker placement display 600 (FIG. 6). One or more graphic overlay options are displayed in obfuscation selection area 610. In step S306, a desired graphic overlay may be positioned on image 410, such as by touching-and-dragging the graphic overlay selection area element 612 onto image 410 to yield graphic overlay 620. Device 120 may enable the user to control numerous characteristics of graphic overlay 620, including, for example, one or more of size, placement, rotation and coloration of graphic overlay 620. In some embodiments, multiple graphic overlays may be applied. Once the user has completed application of graphic overlays, indicium 630 may be selected to return to a post authoring view 700 (FIG. 7).

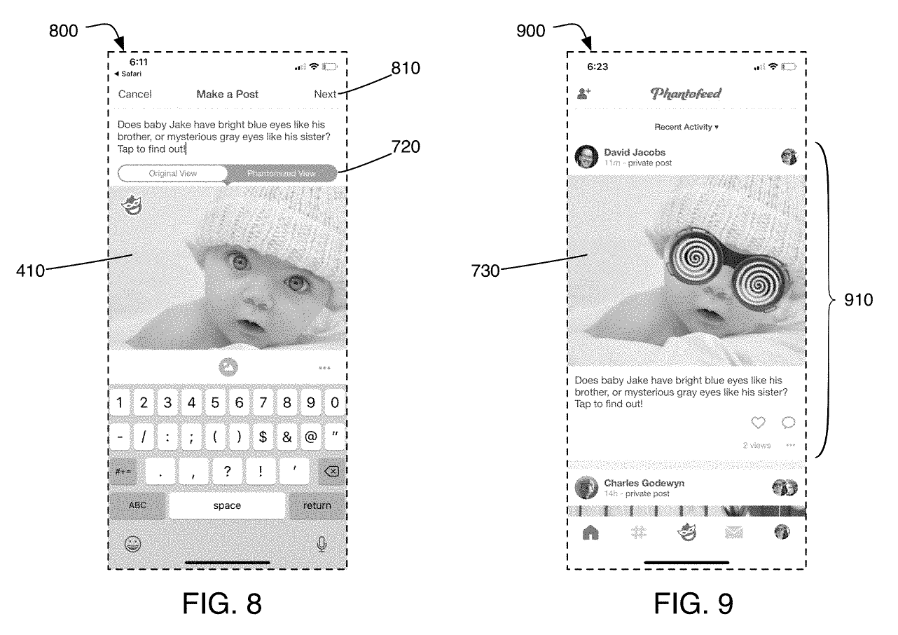

In step S308, a caption may be applied to the post, such as via entry of text in display area 710. Display 700 further includes view toggle mechanism 720, which may be used to toggle between the image view 730 having obfuscations (in this example, graphic overlays) applied (as prepared in step S306) and the original image 410 without obfuscations (as illustrated in display 800 of FIG. 8). In some embodiments, other user interface elements or interactions may be provided, in addition to or in lieu of mechanism 720, to enable a user to switch between the image view 730 having obfuscations and the original image 410. For example, a user may be prompted to tap-and-hold on a rendering of image 730 having obfuscations on a user device touch-sensitive display panel, in order to view original image 410. Such a tap-and-hold Reveal interaction may be provided in addition to or in lieu of, e.g., slider 720. As another example, in some embodiments a user may swipe left across a photo to interactively “wipe away” obfuscations from an image. In step S310, the content item is published, such as by selection of indicium 810.

In some embodiments, post recipients may be specified by the originating user. In some embodiments, posts may be additionally or alternatively published to a group of users, which group may be specified by the originating user, determined algorithmically, or otherwise.

In some embodiments, publication of a post as described herein may be accomplished via insertion of the post into a social media feed of one or more other users. FIG. 3B illustrates an exemplary process for display of a post, such as one created using the process of FIG. 3A. In step S320, the image is displayed in a social media feed, with graphic overlays applied. FIG. 9 illustrates an exemplary publication of a reveal image in a social media feed view. Display 900 provides a social media feed that includes a vertically scrollable sequence of content posts, including post 910, as prepared using the process of FIG. 3 and the user interactions illustrated in FIGS. 4-8. The social media feed of display 900 initially renders post content with graphic overlays applied (i.e. image 730). However, a viewing user may interact with the post (such as, in some embodiments, by tapping on image 730 on a viewing user device having a touch sensitive display, or clicking on image 730 with a viewing user device having a separate display and pointing device) to reveal the original image 410 (step S322).

In some embodiments, server 100 may operate primarily as a mode of transit for reveal post content items that are created locally on an authoring device, for dissemination to and storage upon one or more recipient devices. In such embodiments, creation of the post (e.g. steps illustrated in FIG. 3A) and viewing of a post (e.g. steps illustrated in FIG. 3B) may be implemented locally on user devices, with server 100 storing the user-contributed content only temporarily to facilitate delivery of post content from the originating user to the receiving user(s).

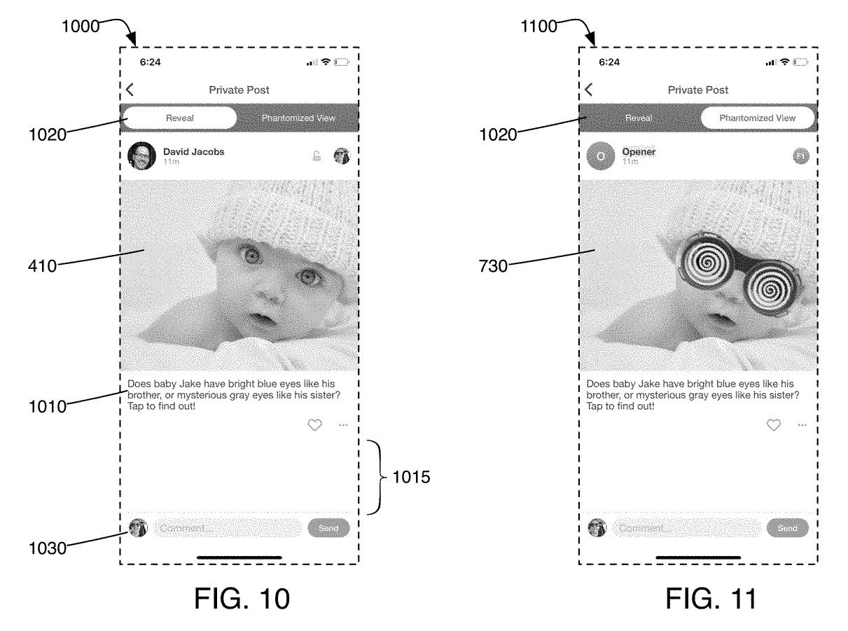

In some embodiments, a revealed view of the content post (without graphic overlays) may be provided to a user directly upon interaction with the content post in a feed view (step S324). FIG. 10 illustrates a revealed content post display that may, in some embodiments, be provided to a viewing user directly upon selection of post 910 from the social media content feed. Original image 410 is immediately shown in revealed content post display 1000, along with caption 1010. Revealed content post display 1000 also includes toggle 1020, which a user may select to toggle between original (revealed) image view 410 and graphic overlay view 730 (as shown in FIG. 11) (step S326). In turn, when graphic overlay view is displayed (step S328), the toggle mechanism may be again selected (step S330) to return to revealed content post display 1000.

In addition to displaying revealed and graphic overlay views, and toggling between them, viewers may comment on, or otherwise respond to, the content post using feedback mechanism 1030. For example, in some embodiments, feedback mechanism 1030 may include a message entry field enabling entry of text and/or image-based comments responsive image 410, graphic overlay view 730, caption 1010 and/or other comments previously entered into feedback mechanism 1030. Messages entered via feedback mechanism 1030, as well as other information pertinent to the content post, may be shown in a scrolling view within display region 1015.

In other embodiments, selection of a content post 910 from the social media feed may initiate a content post view in which graphic overlays are initially applied (e.g. display 1100 in FIG. 11), with a further viewing user interaction required to reveal image 410 without graphic overlays (e.g. tapping of image 730 or view toggle 1020 to transition from initial graphic overlay display 1100 to image reveal display 1000). Such an embodiment is illustrated in the process of FIG. 3C. A content post is initially displayed in a social media feed (step S340). When the viewing user interacts with the content feed item (step S342), a graphic overlay view 1100 is displayed (step S344). From there, the viewing user may toggle (step S346) to display revealed content view 1000 (step S348), and subsequently toggle back (step S350) to display graphic overlay view 1100 (step S344).

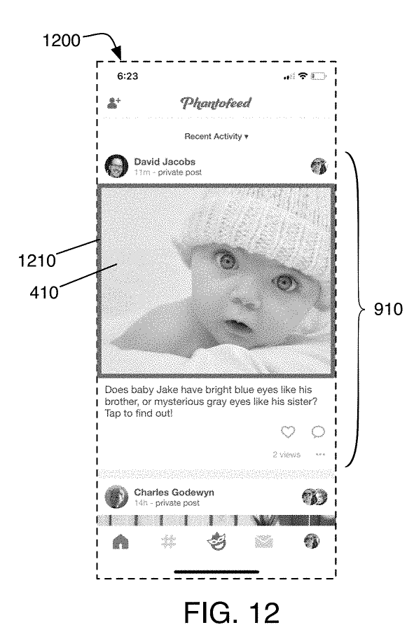

In yet other embodiments, a content reveal may take place directly within a content feed. Such a process is illustrated in FIG. 3D. In step S360, a content post is displayed within a social media feed, in a graphic overlay view (e.g. the view of content post 910 in FIG. 9, showing an image with graphic overlays applied 730). In step S362, a determination is made as to whether a particular viewer interaction with content post 910 has taken place. If not, the content post graphic overlay view continues to be displayed within the viewing user's social media feed. If so, the view provided within the social media feed is changed to a reveal view (step S364). FIG. 12 illustrates an exemplary reveal view within a social media feed, with original image 410 displayed (without graphic overlays) directly within feed content item 910. In some embodiments, it may be desirable to further display a user interface cue indicating that a reveal view is being displayed, such as contrasting image border 1210. A further viewer interaction may be detected (step S366) to toggle back to a graphic overlay view within the viewing user's social media feed (step S360).

As described above, in some embodiments, stickers or graphic overlays may be selected as obfuscations for application to an image in a reveal post. Stickers may provide a humorous and effective mechanism for obscuring a selected portion of an image. However, in other embodiments, other types of obfuscations may additionally or alternatively be made available to an originating user while creating a reveal post. For example, obfuscations may include local area applications of an image filter, such as a blurring effect, recolorization, distortion, or the like.

While certain embodiments of the invention have been described herein in detail for purposes of clarity and understanding, the foregoing description and Figures merely explain and illustrate the present invention and the present invention is not limited thereto. It will be appreciated that those skilled in the art, having the present disclosure before them, will be able to make modifications and variations to that disclosed herein without departing from the scope of the invention or appended claims.

1. A method for displaying a user-contributed content item on an electronic device having a display, via interaction of the device with one or more servers over a digital communications network, the method comprising:
generating, by an originating user using a user computing device interacting with the one or more servers, a user-contributed content item comprising an image;
configuring, by the originating user using the user computing device, an initial view of the user-contributed content item by positioning one or more obfuscations on the image, each obfuscation obscuring a portion of the image;
publishing the initial view of the user-contributed content item to one or more viewing users; and
in response to interaction with the published initial view of the user-contributed content item by a viewing user, displaying the image to the viewing user without the obfuscations.

2. The method of claim 1, in which the one or more obfuscations comprise a graphic overlay.

3. The method of claim 1, in which the one or more obfuscations comprise an image filter.

4. The method of claim 1, in which the step of generating, by an originating user using a user computing device, a social media post comprising an image, comprises the substep of:
uploading the image from the user computing device, the image having previously been captured by a digital camera within the user computing device.

5. The method of claim 1, in which the step of configuring an initial view of the user-contributed content item comprises:
selecting, by the originating user using the user computing device, the obfuscations from amongst a plurality of obfuscation options.

6. The method of claim 1, in which:
the step of publishing the initial view of the user-contributed content item to one or more viewing users comprises: publishing the initial view of the user-contributed content item within a content feed for display on a viewing user computing device; and
the step of displaying the image to the viewing user without the obfuscations comprises: detecting, by a viewing user computing device, selection of the initial view of the user-contributed content item within the content feed; and in response thereto, within the content feed, immediately displaying the image to the viewing user without obfuscations.

7. The method of claim 1, in which:
the step of publishing the initial view of the user-contributed content item to one or more viewing users comprises: publishing the initial view of the user-contributed content item within a content feed for display on a viewing user computing device; and
the step of displaying the image to the viewing user without the obfuscations comprises: detecting, by a viewing user computing device, selection of the initial view of the user-contributed content item within the content feed; and in response thereto, displaying a content post view to the viewing user comprising the image without obfuscations.

8. The method of claim 7, in which the content post view further comprises: a feedback message entry field, and a feedback display region.

9. The method of claim 7, in which the content post view further comprises a view toggle indicia which, upon selection, toggles the content post view between display of the image with obfuscations, and display of the image without obfuscations.

10. The method of claim 1, wherein the one or more servers implement a social media platform and the user-contributed content item comprises a social media post.

11. The method of claim 1, wherein the one or more servers implement a messaging platform and the user-contributed content item comprises a message from the originating user directed to one or more recipient users.

12. A method for displaying a content feed in a social network environment, the method comprising:
(a) displaying a social media content feed comprising a plurality of content items on a personal electronic device display screen, the plurality of content items comprising a variable view content item contributed by an originating user, the variable view content item comprising an image and one or more obfuscations positioned on the image by an originating user having created the variable view content item;
(b) detecting a user interaction with the variable view content item; and
(c) displaying an alternative view of the variable view content item, the alternative view including the image and excluding the one or more obfuscations.

13. The method of claim 12, in which the one or more obfuscations comprise a graphic overlay.

14. The method of claim 12, in which the one or more obfuscations comprise an image filter.

15. The method of claim 12, in which the step of detecting a user interaction with the variable view content item comprises detecting user selection of the variable view content item.

16. The method of claim 12, in which the variable view content item further comprises a text caption.

17. The method of claim 12, in which the variable view content item's one or more obfuscations positioned on the image by the originating user are selected by the originating user.

18. The method of claim 17, in which each variable view content item further comprises a text caption specified by the originating user.
